(19) United States
(12) Patent Application Publication
(10) Pub. No.: US 2012/0173198 A1
(43) Pub. Date: Jul. 5, 2012

(54) Automatic Parking Disc

(76) Inventor: Klaus Larsen, Hoersholm (DK)

(21) Appl. No.: 13/318,839

(22) PCT Filed: May 12, 2009
(86) PCT No.: PCT/IB09/05565

§ 371 Date: Mar. 19, 2012

(51) Int. Cl. G04F 10/00

(52) U.S. Cl. 702/178

(57) ABSTRACT

A method for determining changes between states of a land vehicle is disclosed. The method involves the initial steps of sampling a signal having a signal parameter representing the driving motions of said land vehicle, defining a lower threshold and an upper threshold for said signal parameter. The method further involves the subsequent steps of determining a change from parked to driving if the present state is parked and if said signal parameter is greater than said upper threshold, or alternatively determining a change from driving to parked if the present state is driving and if said signal parameter is smaller than said lower threshold. An automatic parking disc performing the method is also disclosed.

### FIELD OF THE INVENTION

The present invention generally relates to a method for accurately determining the state of a vehicle, and in particular to an automatic parking disc. More specifically, the present invention relates to an autonomous parking disc without any direct couplings to the electronics of the vehicle it is placed in.

### RELATED ART

In disc parking the parking disc shows the arrival time, which is set to the next full hour, half hour, or quarter hour mark on a clock face. For example, if a parking sign indicates a one hour maximum parking time, then the effective maximum parking time is at least 61 to 75 minutes, because of the setting of the clock forward in time.

Parking discs are commonly placed inside a vehicle so that the arrival time can be read from the outside of the vehicle through the windshield or through one of the side-windows at the front. Typically, a parking disc has a traditional clock face with time marks positioned in a circle. A mechanical time indicator or arrow is rotationally connected to the centre of the circle and can be set manually relative to the clock face to indicate the arrival time. The manually operable parking discs are commonly sheet-like objects that can easily be stowed away when not in use. However, there are also parking discs that are bulky, or parking discs that are releasably or permanently attached to the windscreen.

There are also parking discs that automatically indicate the arrival time. In EP1221676A2 and EP1231572 acceleration sensors are suggested as sensors for determining whether a vehicle is in a driving state or a parked state. These kinds of parking discs are associated with the problem that they are not reliable in determining the state of the vehicle, or in determining the transition between states.

Another kind of parking discs is revealed in DE4305266A1, in which it is physically coupled to the electrical system, or more specifically to the ignition, of a vehicle. These parking discs are generally reliable in determining the state of a vehicle. However, they are associated with costly installment procedures and are also susceptible to manipulation via the physical coupling to the electrical system.

WO 2004/114225 discloses an automatic parking disc, wherein a state transition from parked to driving is based on whether an estimate of the acceleration along a single uniform direction exceeds a minimum value.

Another parking disc also employing an accelerometer for the determination of whether a land vehicle is driving or parked is disclosed in EP 1 221 676.

### OBJECT OF THE INVENTION

It is an object of the present invention to provide a reliable determination of changes between states of a vehicle, i.e. whether the state is changed from parked to driving or from driving to parked, by an automatic parking disc. A particular feature of the present invention is that the parking disc is autonomous with respect to the vehicle, for example it is not coupled to the electrical system the vehicle for power or for receiving information about the state of the vehicle. An advantage with the present invention is an automatic and accurate parking disc that can be easily be transferred between and used in different vehicles.

### GENERAL DESCRIPTION

The above object, the above advantage and the above feature together with numerous other objects, advantages and features will be evident from the detailed descriptions given below of preferred embodiments according to the present invention. The objects, advantages and features are according to a first aspect of the present invention obtained by a method for determining changes between states of a land vehicle from parked to driving and from driving to parked comprising the steps of: sampling a signal having a signal parameter representing the driving motions of the land vehicle, defining a lower threshold and an upper threshold for the signal parameter, determining a change from parked to driving if the present state is parked and if the signal parameter is greater than the upper threshold, or alternatively determining a change from driving to parked if the present state is driving and if the signal parameter is smaller than the lower threshold.

Here, the states in question are parked or driving. Further, the land vehicle may be any vehicle capable of travelling on land, such as road vehicles and off-road vehicles. Examples of road vehicles are cars, buses, trucks and vans. Examples of off-road vehicles are tractors; forklifts, cranes, bulldozers and Golf carts. The land vehicle may be wheeled, tracked, railed, or skied.

The driving motions of the land vehicle are primarily a result from the movement of the land vehicle across land, e.g. due to accelerations, decelerations, direction changes of the land vehicle, e.g. turns. Uneven road surfaces may also result in driving motions, e.g. due to bumps or hollows in the roads. Hence, the signal parameter may essentially represent the changes in velocities and directions relative to the surroundings. For example, the signal parameter may be considered as having the unit of meters per seconds squared. Naturally, the value of the signal parameter changes over time when the land vehicle is in the state of driving.

The method for determining a change of state of a land vehicle may further comprise the steps of determining an arrival time from a reference time if the change from driving to parked is determined, and displaying the arrival time. These features have the advantages of easier setting of the arrival time in an automatic parking disc and that they enable the arrival time to be viewed at a later point in time. The method for determining a change of state of a land vehicle may further comprise the step of rounding the arrival time to the next full quarter of an hour. If the arrival time is indicated with hands on a clock face, this has the advantage of clearer indication than if every minute is indicated.

The method for determining a change of state of a land vehicle may further comprise the step of discontinuing the displaying of the arrival time if the change from parked to driving is determined. This feature has the advantage of an easier resetting of the arrival time in an automatic parking disc and also the advantage that it enables the parking time to be displayed during whole time in the parked state.

The method for determining a change of state of a land vehicle may further comprise the step of filtering the signal to suppress the signal outside a frequency window. This feature has the advantage of a more accurate determination of a change between states. For example, motions induced by the wind on a parked land vehicle may be filtered out at the lower frequencies, while engine vibrations may be filtered out at the higher frequencies for a land vehicle in a driving state. The frequency window may have its lower cut-off frequency and its upper cut-off frequency within approximately 0.01 Hz and approximately 1 Hz. More specifically, the frequency window may have its lower cut-off frequency at approximately 0.03 Hz and its upper cut-off frequencies at approximately 0.5 Hz. It has been show that with these particular cut-off frequencies the changes between states can be accurately determined, where the signal primarily represents changes in velocities and directions relative to the surroundings. A particular advantage of the proposed cut-off frequencies is that the method for determining a change of state of a land vehicle does not depend on combustion engines to function, which means that it also works for vehicles having electrical motors.

Additionally or alternatively, the motions of the land vehicle may be approximately vertical, approximately parallel to the primary driving direction of the land vehicle, or a combination thereof. Due to the suspensions of many land vehicles, which usually allow for significant sideways rocking, by leaving out perpendicular or sideways motions, the accuracy in determining a change between states is made more accurate.

The sampling frequency in the step of sampling the signal may be in the range between approximately 0.1 second and approximately 30 seconds. The method for determining a change of state of a land vehicle may further comprise the step of lowering the time-resolution of the signal parameter. The lowering of the time-resolution may be achieved through an integration of the signal parameter over a time interval. The length of the time interval may be in the range of approximately 10 seconds to approximately 100 seconds. All of these features and steps have the advantage that they increase the accuracy in determining a change between states of the more common land vehicles.

The objects, advantages and features are according to a second aspect of the present invention obtained by an automatic parking disc having a front face for being viewed from the outside of a land vehicle and a back face for being viewed from the inside of the land vehicle. The automatic parking disc comprises one or more processors for performing the method of determining a change of state of a land vehicle according to the first aspect of the present invention, an accelerometer coupled to the processor to provide the signal, a chronometer to provide the reference time to the processor, and an autonomous power source to provide the automatic parking disc with electrical power.

The accelerometer typically measures its acceleration or change in velocity relative to the surroundings. It may be a single- or multi-axis model, i.e. the accelerometer may measure velocity changes in a single direction, or in several directions simultaneously. The chronometer may comprise any type of electronic or electro-mechanical oscillator, e.g. a quartz oscillator having a base resonance frequency of 32768 Hz. Naturally, the chronometer may have to be calibrated in order to provide an appropriate reference time. The autonomous power source may be an electrical battery, or it may be a solar or photovoltaic cell storing some of its power in an electrical battery or capacitor. Autonomous should here be understood as not depending on external power from the vehicle.

The automatic parking disc may further comprise a first indicator on the front face to display the arrival time. This has the advantage that, if the parking disc is attached to the windscreen, or for that matter on any window of a vehicle, the arrival time can be seen from the outside of the vehicle. The first indicator may comprise a clock face on the front face having twelve hour differentiating marks in a closed loop, a thirty-minutes differentiating mark between each pair of neighboring hour differentiating marks, and a fifteen-minutes differentiating mark between each neighboring thirty-minutes and hour differentiating marks. The automatic parking disc may further comprise a liquid-crystal-display to display the arrival time by a pointer to any of the hour, thirty-minutes, and fifteen-minutes differentiating marks. All these technical features have the advantage of improving the displaying of the arrival time.

The chronometer may further provide a reference date, and the automatic parking disc may further comprise a second indicator on the back face to display the reference time and the reference date. Naturally, the chronometer may have to be calibrated in order to provide an appropriate reference time and reference date. Hence, the automatic parking disc may further comprise a first manual input to manually set the reference time and/or the reference date. This has the advantage that the reference time can be adjusted to any Coordinated Universal Time or UTC, i.e. the parking disc can easily be used in two different time-zones by a simple recalibration of the chronometer.

The automatic parking disc may further comprise a second manual input to manually set the arrival time. This has the advantage that if the time-limited parking starts at a particular time that is later than the present lime, the arrival time can be set to the later particular time. This way, it is not necessary to go back to a parked vehicle to set the arrival time when the time-limited parking starts.

The automatic parking disc may further comprise a support to releasably attach the automatic parking disc to a windshield with the front face facing the windshield. This has the advantage that the arrival time can be seen from the outside when the land vehicle is in a parked state.

### BRIEF DESCRIPTION OF THE FIGURES

Additional objects and features according to the present invention will be more readily apparent from the following detailed description of a preferred embodiment presented in conjunction with the figures:

FIG. 1 is a schematic block diagram illustrating the method for determining a change of state of a land vehicle.

FIG. 2 is a graph illustrating in the frequency domain a low-pass filtering of the sampled signal.

FIG. 3 is a graph Illustrating in the frequency domain another low-pass filtering of the sampled signal, where the cut-off frequency is lower than in FIG. 2.

FIG. 4 is a graph illustrating in the frequency domain the subtraction of the signal after passing the low-pass filtering of FIG. 3 from the signal after passing the low-pass filtering of FIG. 2, thus effectively representing a band-pass filtering.

FIG. 5 is a phase diagram illustrating the hysteresis of the method for determining a change of state of a land vehicle.

FIG. 6 is a block diagram illustrating the principal electronic components of an automatic parking disc.

FIG. 7 is a front view of an automatic parking disc.

FIG. 8 is a side view of an automatic parking disc.

FIG. 9 is a back view of an automatic parking disc.

### DETAILED DESCRIPTION

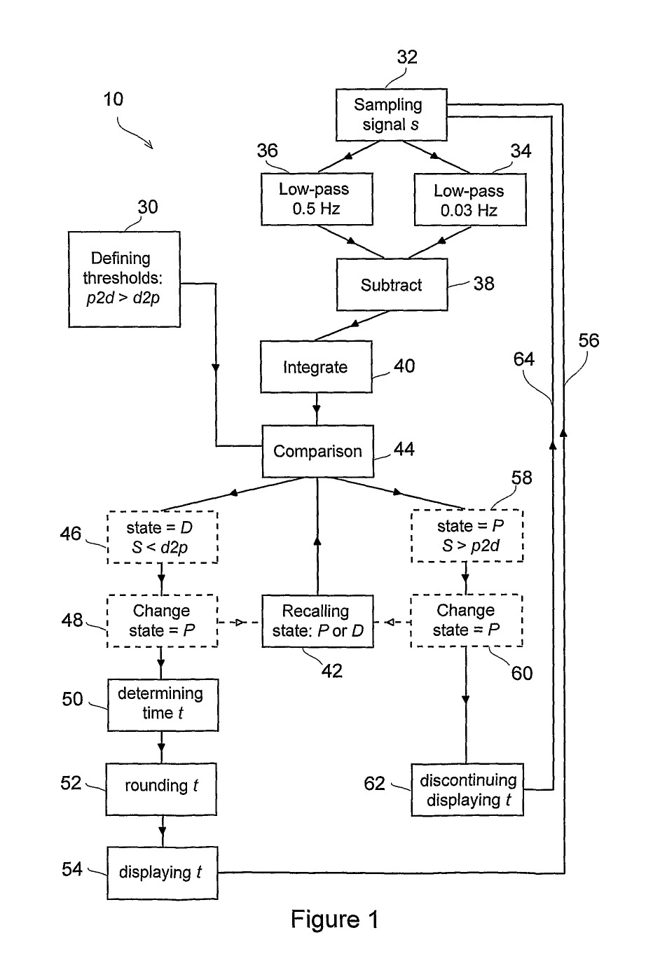

FIG. 1 is a schematic block diagram 10 illustrating a preferred embodiment of the method for determining a change of state of a land vehicle. Two thresholds p2d and d2p are defined 30, where the former is higher than the latter. The signal s is sampled 32 at a sampling frequency of 16 Hz and subjected to a low-pass filter 36 having a cut-off frequency at approximately 0.5 Hz, giving a first filtered signal. The sampled signal s is also subjected to another low-pass filter 34 having a cut-off frequency at approximately 0.03 Hz, giving a second filtered signal. The second filtered signal is subtracted 38 from the first filtered signal filtered signal to. The signal is then integrated 40 over a time window of 16 s, thereby giving the signal parameter S.

The thresholds p2d and d2p are set by calibration with respect to the properties of the signal parameter S in the state of parked and in the state of driving for a car on a road surface.

The signal parameter S is compared 44 with the thresholds p2d and d2p and the present state, either parked P or driving D, is recalled 42. If the present state is driving D and the signal parameter S is smaller than d2p 46, then the present state is changed 48 to parked P, which is stored to be recalled later 42. Next, an arrival time t is determined 50 from a reference time and rounded to the closest future quarter of an hour. The rounded arrival time is then displayed 54. Subsequently, the sampling 32 of a new signal s is performed iteratively 56. If the present state is parked P and the signal parameter S is larger than p2d 58, then the present state is changed 60 to driving D, which is stored to be recalled later 42. Next, the displaying of the arrival time t is discontinued 62. Subsequently, the sampling 32 of a new signal s is performed iteratively 64.

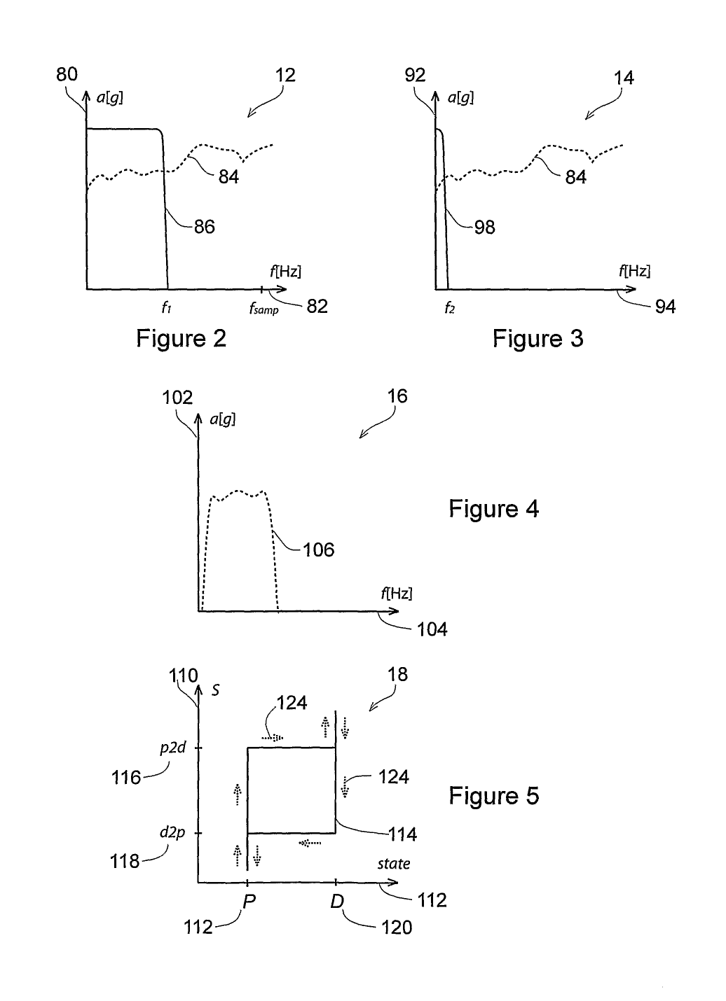

FIG. 2 is a graph 12 illustrating in the frequency domain a low-pass filtering of the sampled signal 84. The ordinate 80 shows the changes in velocities a being normalized to a single gravity g, i.e. having the unit of meters per seconds squared, while the abscissa 82 shows the frequency f in the unit of Hertz. An example of a signal is represented by a dashed line 84. A low pass filter, having the cut-off frequency f₁ that is less than half of the sampling frequency fₛₐₘₚₗₑ is shown as a solid line 86. FIG. 3 is a graph 14 illustrating in the frequency domain a low-pass filtering of the same sampled signal 84 as in FIG. 2. Here, the ordinate 92 also shows the changes in velocities a being normalized to a single gravity g, while the abscissa 94 shows the frequency f in the unit of Hertz. A low pass filter, having the cut-off frequency f₂ that is less than the cut-off frequency f₁ of FIG. 2 is shown as a solid line 98.

FIG. 4 is a graph 16 illustrating in the frequency domain the subtraction of the signal after passing the low-pass filter of FIG. 3 from the signal after passing the low-pass filter of FIG. 2. Thus, the filtered and subtracted signal 106 is effectively within the upper cut-off frequency f₁ and the lower cut-off frequency f₂ As in the previous FIGS. 2 and 3, the ordinate 102 shows the changes in velocities a being normalized to a single gravity a while the abscissa 104 shows the frequency f in the unit of Hertz. The same scales on the corresponding coordinate axis of FIGS. 2 to 4 have been used.

FIG. 5 is a phase or state diagram 18 illustrating the hysteresis of the method for determining a change of state of a land vehicle. The ordinate 100 shows the values of the signal parameter a while the abscissa 112 shows to the state of the land vehicle. The hysteresis curve 114 is shown as a solid line, where the dashed arrows 124 indicate the direction of changes between states. The transition from parked P 120 to driving D 122 requires the signal parameter S to be larger than the threshold p2d 116, while the transition from driving D 120 to parked P 120 requires the signal parameter S to be smaller than the threshold d2p 118, where the threshold p2d 116 is higher than the threshold d2p 118.

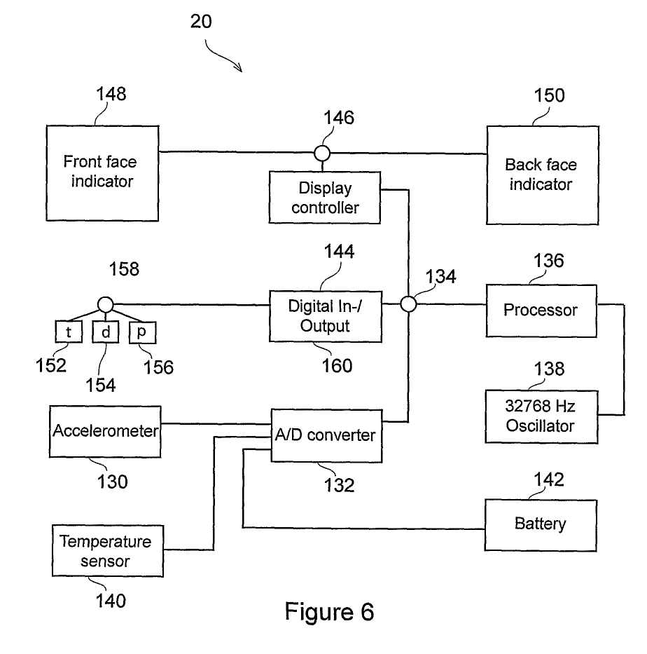

FIG. 6 is a block diagram 20 illustrating the principal electronic components of a preferred embodiment of the automatic parking disc. An Accelerometer 130 samples an analog signal at least partly representing the driving motions of a vehicle. The Accelerometer 130 is set to primarily measure driving motion along in a vertical direction and in the driving direction of the vehicle. Naturally, this may require that the Accelerometer 130 is placed in the appropriate orientation for this to be achieved. The analog signal is sent to an Analog-to-Digital converter 132 converting it to a digital signal. The digital signal is sent via a Control/Data bus 134 to a Processor 136 in connection with a quartz Oscillator 138 having a base resonance frequency of 32768 Hz. The Processor 136 and the quartz oscillator 138 together define a chronometer for providing a reference time and a reference date. A Temperature sensor 140 also sends an analog temperature signal to the Analog-to-Digital converter 132 to give a digital temperature signal, which is sent via the Control/Data bus 134 to the Processor 136. The digital temperature signal is employed for correcting or partly compensating for temperature induced shifts in the resonance frequency of the quartz oscillator 138.

The Processor performs the method described in conjunction with FIGS. 1 to 5. Naturally, the Processor 136 comprises a memory unit for storing the corresponding algorithms and the present state of the vehicle.

If the change of state from driving to parked is determined, the Processor 136 sends a signal to the Display controller 144 via the Control/Data bus 134, which in turn sends a display signal via the Display bus 146 to the Front face indicator 148 to display the arrival time. If the change of state from parked to driving is determined, the Processor 136 sends a signal to the display controller 144 via the Control/Data bus 134 to stop display the arrival time on the Front face indicator 148. The processor 136 also sends a signal to the display controller 144 via the Control/Data bus 134 to continuously display the reference time and reference date on the Back face indicator 150.

A key Input 152 enables a time recalibration signal to be sent to the Processor 136 via a Digital In-/Output and the Control/Data bus 134 to manually set the reference time. Another key input 154 enables a date recalibration signal to be sent to the Processor 136 via a Digital In-/Output and the Control/Data bus 134 to manually set the reference date. Similarly, a key input 156 enables an arrival-time recalibration signal to be sent to the Processor 136 via a Digital In-/Output and the Control/Data bus 134 to manually set the arrival time.

The electronic components of the parking disc are provided with power via an electrical battery 142. The output power of the battery is monitored by the Processor 136 via the Analog-to-Digital converter 132 and the Control/Data bus 134.

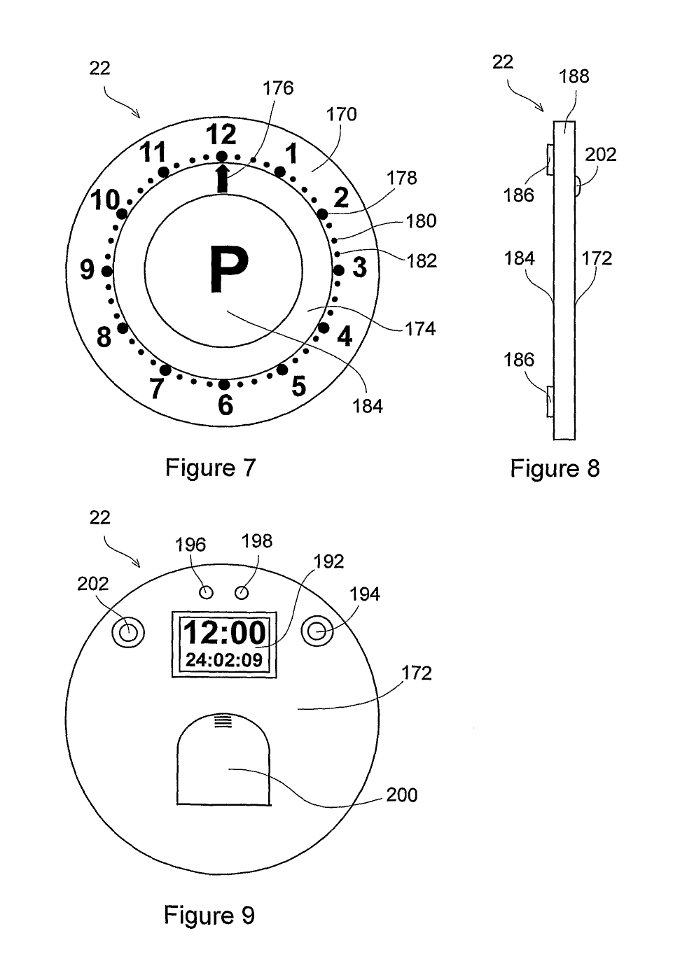

FIG. 7 is a front view of a preferred embodiment of the automatic parking disc 22. The cylindrical automatic parking disc 22 has a front face 184 with a clock face 170. The clock face 170 is provided with twelve hour differentiating marks 178 in a closed loop and a thirty-minute differentiating mark 180 between each pair of neighboring hour differentiating marks 178. Further, the clock face 170 is also provided with a fifteen-minutes differentiating mark 182 between each neighboring thirty-minutes 180 and hour 178 differentiating mark. On the inside of the clock face 170 is a liquid-crystal-display 174 showing an arrow 176 indicating the arrival time when the state is changed from driving to parked. The arrow 176 points either at an hour differentiating mark, a thirty-minutes differentiating mark, or a fifteen-minutes differentiating mark.

FIG. 8 is a side view of a preferred embodiment of the automatic parking disc 22. The depth of the side 188 of the cylindrical parking disc 22 is significantly smaller than the diameter of its front 184 or back 172 faces, thereby giving it a flat profile. The front face is provided with a transparent suction ring 186 on the dock face 170 to enable a releasable attachment of the parking disc onto the inside of a windshield with the front face 184 facing outwards from the vehicle. The transparent cover 202 of a battery indicator lamp, which is turned on at low battery energy levels, protrudes from the back face 172.

FIG. 9 is a back view of a preferred embodiment of the automatic parking disc 22. The cylindrical automatic parking disc 22 has a back face 172 provided with a liquid-crystal-display 192 for indicating the reference time and reference date. The parking disc 22 is also provided with an autonomous power source in the form of a battery housed behind a battery lid 200. The back face 172 is also provided with a manual key input 196 for setting the reference time, a manual key input 198 for setting the reference date, and manual key input 194 for setting the arriving time.

1. A method (10) for determining changes between states of a land vehicle from parked to driving and from driving to parked comprising the steps of:
sampling a signal (32) having a signal parameter representing the driving motions of said land vehicle,
defining a lower threshold and an upper threshold (30) for said signal parameter,
determining a change from parked to driving (44, 58, 60) if the present state is parked and if said signal parameter is greater than said upper threshold, or alternatively
determining a change from driving to parked (44, 46, 48) if the present state is driving and if said signal parameter is smaller than said lower threshold.

2. The method (10) for determining a change of state of a land vehicle according to claim 1 further comprising the steps of:
determining an arrival time (50) from a reference time if said change from driving to parked is determined (44, 46, 48), and
displaying said arrival time (54).

3. The method (10) for determining a change of state of a land vehicle according to claim 2 further comprising the step of:
rounding said arrival time to the next full quarter of an hour.

4. The method (10) for determining a change of state of a land vehicle according to any of the claims 2 to 3 further comprising the step of:
discontinuing the displaying of said arrival time (62) if said change from parked to driving is determined (44, 58, 60).

5. The method (10) for determining a change of state of a land vehicle according to any of the claims 1 to 4 further comprising the step of:
filtering (34, 36) said signal to suppress said signal outside a frequency window.

6. The method (10) for determining a change of state of a land vehicle according to claim 5, wherein said frequency window has its lower cut-off frequency (34) and its upper cut-off frequency (36) within approximately 0.01 Hz and approximately 1 Hz.

7. The method (10) for determining a change of state of a land vehicle according to any of the claims 5 to 6, wherein said frequency window has its lower cut-off frequency (34) at approximately 0.03 Hz and its upper cut-off frequencies (36) at approximately 0.5 Hz.

8. The method (10) for determining a change of state of a land vehicle according to any of the claims 1 to 7, wherein said motions of said land vehicle are approximately vertical, approximately parallel to the primary driving direction of the land vehicle, or a combination thereof.

9. The method (10) for determining a change of state of a land vehicle according to any of the claims 1 to 8, wherein the sampling frequency in the step of sampling said signal (32) is in the range between approximately 0.1 second and approximately 30 seconds.

10. The method (10) for determining a change of state of a land vehicle according to any of the claims 1 to 9 further comprising the step of:
lowering the time-resolution (40) of said signal parameter.

11. The method (10) for determining a change of state of a land vehicle according to claim 10, wherein said lowering (40) of the time-resolution is achieved through an integration of said signal parameter over a time interval.

12. The method (10) for determining a change of state of a land vehicle according to claim 11, wherein the length of said time interval is in the range of approximately 10 seconds to approximately 100 seconds.

13. An automatic parking disc (22) having a front face (184) for being viewed from the outside of a land vehicle and a back face (172) for being viewed from the inside of said land vehicle, said automatic parking disc (22) comprising:
one or more processors (136) for performing the method (10) of determining a change of state of a land vehicle according to any of the claims 1 to 12,
an accelerometer (130) coupled to said processor (136) to provide said signal,
a chronometer (138) to provide said reference time to said processor (136), and
an autonomous power source (142) to provide said automatic parking disc with electrical power.

14. The automatic parking disc (22) according to claim 13 further comprising:
a first indicator (148, 174) on said front face (184) to display said arrival time.

15. The automatic parking disc (22) according to claim 14, wherein said first indicator (148, 174) comprises:
a clock face (170) on said front face (184) having:
twelve hour differentiating marks (178) in a closed loop,
a thirty-minutes differentiating mark (180) between each pair of neighboring hour differentiating marks (178), and
a fifteen-minutes differentiating mark (182) between each neighboring thirty-minutes (180) and hour (178) differentiating marks.

16. The automatic parking disc (22) according to any of the claims 14 to 15, wherein said first indicator (148, 174) further comprises:
a liquid-crystal-display (174) to display said arrival time by a pointer (176) to any of said hour (178), thirty-minutes (180), and fifteen-minutes (182) differentiating marks.

17. The automatic parking disc (22) according to any of the claims 13 to 16, wherein said chronometer (138) further provides a reference date, and said automatic parking disc (22) further comprising:
a second indicator (150, 192) on said back face (172) to display said reference time and said reference date.

18. The automatic parking disc (22) according to any of the claims 13 to 17 further comprising:
a first manual input (194) to manually set said reference time and/or said reference date.

19. The automatic parking disc (22) according to any of the claims 13 to 18 further comprising:
a second manual input (196, 198) to manually set said arrival time.

20. The automatic parking disc (22) according to any of the claims 13 to 19 further comprising:
a support (186) to releasably attach said automatic parking disc (22) to a windshield with said front face (184) facing said windshield.
